(19) United States
(12) Patent Application Publication
(10) Pub. No.: US 2025/0184214 A1
(43) Pub. Date: Jun. 5, 2025

(54) LOCATING SOURCES OF PACKET LOSS IN A DISTRIBUTED NETWORK

(71) Applicant: Microsoft Technology Licensing, LLC, Redmond, WA (US)

(72) Inventors: Parvez ANANDAM, Seattle, WA (US); Imran Siraj KORADIA, Kirkland, WA (US); Maria FICIU, Bellevue, WA (US); Sahithi BONALA, Seattle, WA (US); David Aaron MALTZ, Bellevue, WA (US)

(21) Appl. No.: 18/527,351

(22) Filed: Dec. 3, 2023

(51) Int. Cl. H04L 41/0677; H04L 41/12; H04L 43/06; H04L 43/0829

(52) U.S. Cl. CPC H04L 41/0677; H04L 41/12; H04L 43/06; H04L 43/0829

(57) ABSTRACT

Solutions are disclosed that locate sources of packet loss in a distributed network. A network topology is constructed, and set of tracing packets is tagged. Packets are captured, including from host nodes (e.g., packet source and destination) and the tag is used as a filter to identify the tracing packets among the captured packets. The packet capture results are used to identify which (if any) of the tracing packets are dropped, and the network topology is used to identify each dropped packet's last-visited network node. This enables the generation of a network performance report indicating the location of the dropped packet(s) (if any). Some examples also include latency information in the network performance report.

### BACKGROUND

In large, distributed networks, packet loss, packet corruption and latency are essentially inevitable, due to hardware failures and software bugs. Each network component in an end-to-end path may individually appear to be healthy, according to its own health model, and yet still fail to deliver data packets reliably to the next network component in the path. Efficiently locating such a network component, as a source of packet loss, corruption, or delay, is becoming increasingly challenging due to the growing sophistication of software define network (SDN) overlays and complexities of physical networks.

### SUMMARY

The disclosed examples are described in detail below with reference to the accompanying drawing figures listed below. The following summary is provided to illustrate some examples disclosed herein.

Example solutions for locating sources of packet loss in a distributed network include collecting topology data for a packet switched network; building a network topology of network nodes of the packet switched network, using the collected topology data; tagging a first set of tracing packets with a tag; capturing packets from the packet switched network, including packets from a host device, the captured packets including a second set of tracing packets; identifying the second set of tracing packets within the captured packets using the tag; identifying, using the second set of tracing packets and the first set of tracing packets, a dropped or corrupted tracing packet; identifying, for the dropped tracing packet, using the network topology, a last-visited network node; and generating a network performance report indicating the dropped tracing packet and the last-visited network node.

### BRIEF DESCRIPTION OF THE DRAWINGS

The disclosed examples are described in detail below with reference to the accompanying drawing figures listed below:

FIG. 1 illustrates further detail for the an example architecture that advantageously locates sources of packet loss in a distributed network;

FIG. 2 illustrates further detail for an exemplary distributed (packet switched) network, as may be used in the architecture of FIG. 1;

FIG. 3 illustrates further detail for an exemplary distributed packet capture and analysis service, as may be used in the example architecture of FIG. 1;

FIG. 4 illustrates yet further detail for the distributed packet capture and analysis service of FIG. 3;

FIG. 5 illustrates an exemplary state machine, as may be used in the example distributed packet capture and analysis service of FIG. 3;

FIG. 6 illustrates an exemplary packet tagging scheme, as may be used in the example architecture of FIG. 1;

FIG. 7 shows a flowchart illustrating exemplary operations for constructing a network topology for the distributed network of FIG. 1;

FIG. 8 illustrates another exemplary state machine, as may be used in the example distributed packet capture and analysis service of FIG. 3;

FIG. 9 illustrates an exemplary user interface (UI) showing an exemplary network performance report, as may be used in the example architecture of FIG. 1;

FIGS. 10 and 11 show additional flowcharts illustrating exemplary operations that may be performed when using example architectures, such as the architecture of FIG. 1; and

FIG. 12 shows a block diagram of an example computing device suitable for implementing some of the various examples disclosed herein.

Corresponding reference characters indicate corresponding parts throughout the drawings.

### DETAILED DESCRIPTION

Solutions are disclosed that locate sources of packet loss in a distributed network. A network topology is constructed, and set of tracing packets is tagged. Packets are captured, including from host nodes (e.g., packet source and destination) and the tag is used as a filter to identify the tracing packets among the captured packets. The packet capture results are used to identify which (if any) of the tracing packets are dropped, and the network topology is used to identify each dropped packet's last-visited network node. This enables the generation of a network performance report indicating the location of the dropped packet(s) (if any). Some examples also include latency information in the network performance report.

In some examples, the network comprises a packet switched wide area network (WAN) that provides for data flows between different regions, such as geographically-dispersed data centers, carrying data traffic among sets of servers. In some examples, the network uses tunnels, and probe packets within the tunnels trigger the process to detect the sources of dropped packets. In some examples, packet encapsulation is used to identify incoming and outgoing traffic for network nodes.

Aspects of the disclosure solve multiple problems that are necessarily rooted in computer technology, such as improve the responsiveness of distributed networks by improving the speed, precision, and reliability of network troubleshooting. This has the benefit of enabling a higher amount of data traffic to flow on a network having a given number of routers, or reducing the number of routers while preserving a data traffic capacity. This is accomplished by at least, capturing packets from a packet switched network, including packets from a host device, and identifying, for a dropped tracing packet, using a network topology, a last-visited network node.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

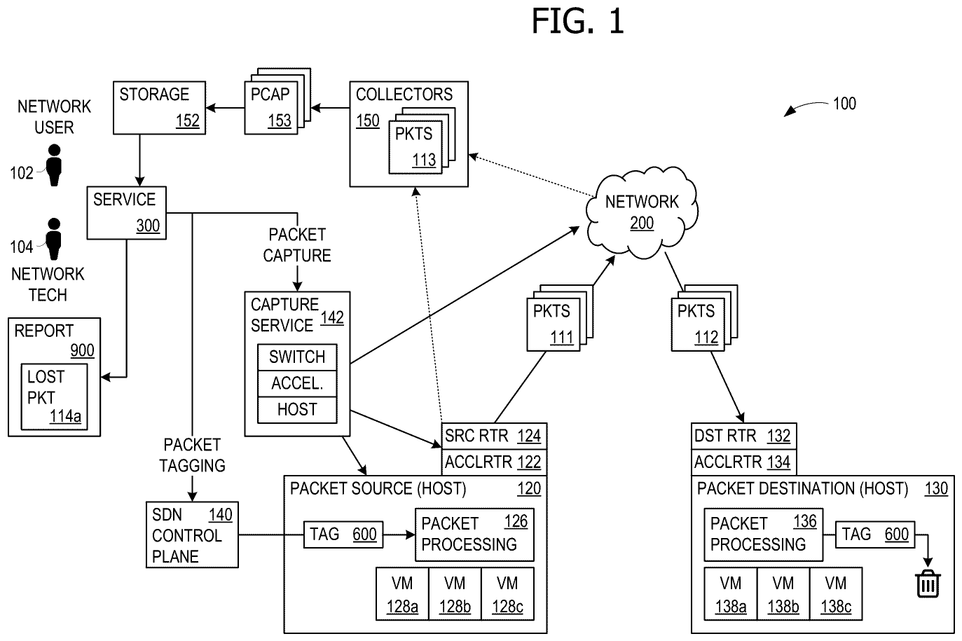

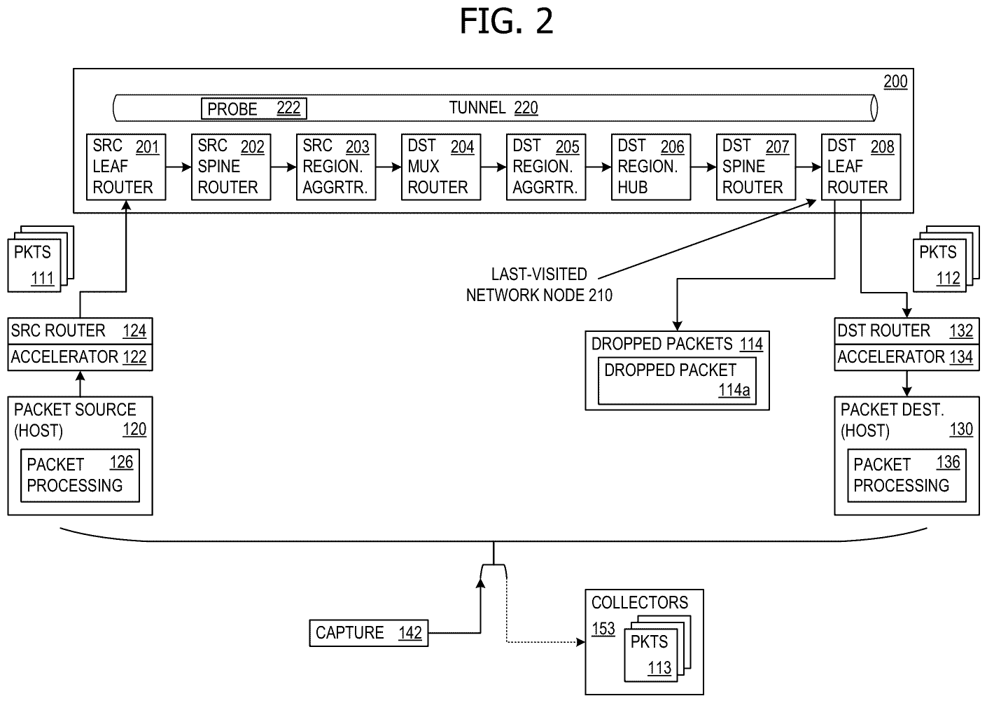

FIG. 1 illustrates an example architecture 100 that advantageously locates sources of packet loss in a distributed network, e.g., a packet switched network 200. In some examples, packet switched network 200 comprises a wide area (WAN) and/or a software defined network (SDN), although the techniques disclosed herein may apply to other classes of packet switched networks. In architecture 100, packet switched network 200 carries data, such as for example, replication data (for crash recovery) from one data center to another data center, possibly in a different geographical region. Packet switched network 200 is described in further detail below, in relation to FIG. 2.

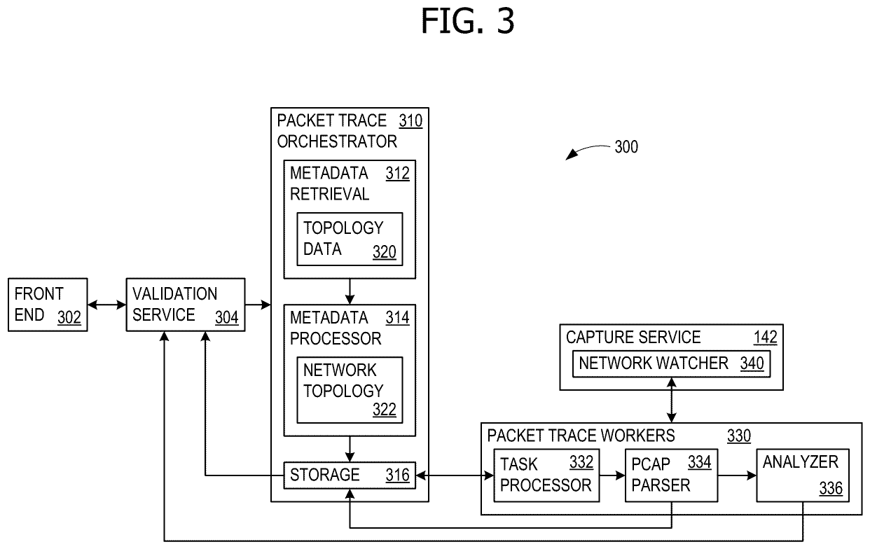

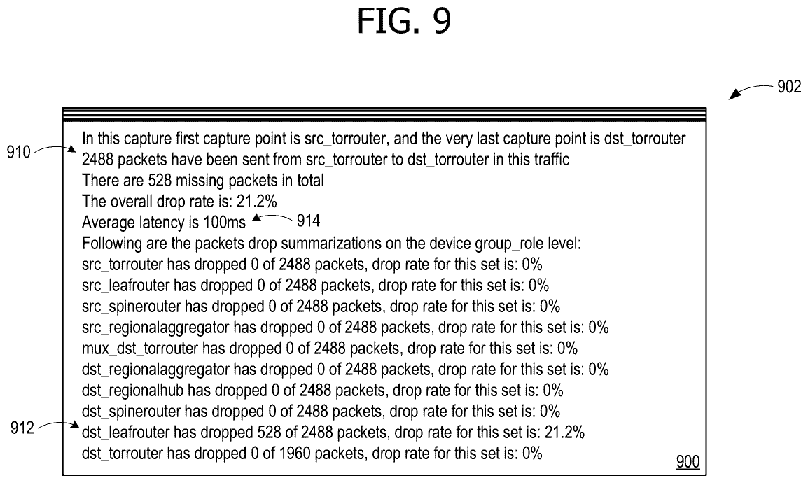

A network user 102, employing packet switched network 200 to transfer data from a packet source 120 (e.g., a first host node) to a packet destination 130 (e.g., a second host node) identifies a drop in performance, and notifies a network technician 104, or other contact point (whether human or an electronic service). Network technician 104, or an automated process, then employs a distributed packet capture and analysis service 300, which is described in further detail below, in relation to FIG. 3. Distributed packet capture and analysis service 300 then pinpoints (locates) the source of packet loss or delay in packet switched network 200 using coordinated packet capture and automated analysis, and generates a network performance report 900 indicating at least one dropped 114a and the source of the loss, and/or a source of a delay. An example network performance report 900 is shown later, in FIG. 9.

Distributed packet capture and analysis service 300 uses a set of tracing packets 111 sent into packet switched network 200 by packet source 120, and uses packet capture to collect captured packets 113, which include set of tracing packets 112 received by packet destination 130. Dropped tracing packet 114a may be identified by its inclusion within set of tracing packets 111 and its absence from set of tracing packets 112. In some examples, captured packets 113 also includes set of tracing packets 111. In some examples, network user 102 identifies packet source 120 and packet destination 130 to network technician 104, which is then provided to distributed packet capture and analysis service 300. In some examples, network user 102 identifies the network flow 5-tuple of the traffic flow experiencing performance degradation to network technician 104, whereas in some examples, distributed packet capture and analysis service 300 determines the network flow 5-tuple from the identification of packet source 120 and packet destination 130. In some examples, all of set of tracing packets 111 have the same network flow 5-tuple (generically, network flow N-tuple).

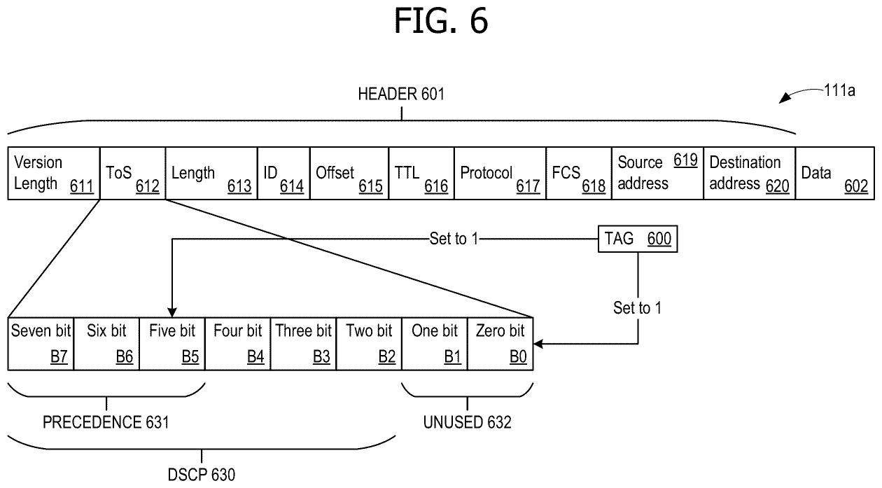

Distributed packet capture and analysis service 300 instructs an SDN control plane 140 to tag set of tracing packets 111 with a tag 600, which is described in further detail below, in relation to FIG. 6. Tagging may occur within a host node virtual filtering platform (VFP), such as packet processing 126 of packet source 120. Additional possible tagging points include content delivery network (CDN) edge routers and internet edge routers. Set of tracing packets 111 may include normal data traffic being sent by packet source 120, under the direction of network user 102, and/or synthetic data traffic used in an attempt to replicate performance problems reported by network user 102.

In the illustrated example, packet source 120 is a host node that is hosting three virtual machines (VMs), a VM 128a, a VM 128b, and a VM 128c, which send data traffic to three corresponding VMs hosted by packet destination 130 (another host node), a VM 138a, a VM 138b, and a VM 138c. To minimize the risk of the diagnosis activity creating its own anomalies, another VFP, such as packet processing 136 of packet destination 130 removes tag 600. Set of tracing packets 111 may be this VM-to-VM data traffic, in some scenarios.

Distributed packet capture and analysis service 300 also instructs a packet capture service 142 to capture data packets traversing packet switched network 200, as well as packets transmitted by packet source 120 and received by packet destination 130. Packet capture service 142 may include specific functionality for capturing packets from network switching equipment (e.g., routers and muxes), network accelerators, and host nodes. In some examples, packet capture service 142 uses NetAnalytics, which has purpose-built capture drivers that are able to packets prior to application of VFP rules for incoming traffic and after application of VFP rules for outgoing traffic. In some examples, packet capture uses rules and filters specifying region, cluster and node, along with source and destination internet protocol (IP) addresses, protocol, and other factors. Some examples may use virtual IP (VIP) addresses as the destination. The capture drivers collect the relevant packets (e.g., captured packets 113) with collectors 150 and save them as pcap-extension files 153 locally before uploading them to storage 152. Distributed packet capture and analysis service 300 retrieves pcap-extension files 153 from storage 152 for analysis.

Packets are captured from the host nodes (packet source 120 and packet destination 130) and network nodes within packet switched network 200. In some examples, packets are also captured from a network accelerator 122 of packet source 120, a source router 124 at packet source 120, a destination router 132 at packet destination 130, and a network accelerator 134 of packet destination 130.

FIG. 2 illustrates further detail for packet switched network 200. Packet switched network 200 includes several network nodes 201-208. Network node 201 is shown as a source leaf router, network node 202 is shown as a source spine router, network node 203 is shown as a source regional aggregator, network node 204 is shown as a destination mux router such as a Top of Rack (ToR), network node 205 is shown as a destination regional aggregator, network node 206 is shown as a destination regional aggregator, network node 207 is shown as a destination spine router, and network node 208 is shown as a destination leaf routers. In some examples, source router 124 and destination router 132 are also ToRs.

In the illustrated example, some packets are dropped by network node 208, between network node 208 and destination router 132, or are otherwise not indicated as received by destination router 132. These are identified as set of dropped tracing packets 114, which includes dropped tracing packet 114a, as well as possibly other packets. For set of dropped tracing packets 114, the final node identifiable as having been visited, last-visited network node 210, is network node 208. This is reflected in the example network performance report 900, described below in relation to FIG. 9. It should be noted that the designation of last-visited network node 210 is specific to dropped tracing packet 114a. If another packet is dropped by a different node, other than network node 208, that other dropped packet will have a different last-visited network node 210.

As indicated in FIG. 2, each of network nodes 201-208, packet processing 126 and 136, network accelerators 122 and 134, source router 124, and destination router 132 are provided commands (e.g., to their local capture drivers) to capture packets, and packets are collected from each as captured packets 113. Some examples use packet-mirroring during capture. Also indicated in FIG. 2, is that dropped tracing packets 114 is the portion of set of tracing packets 111 that is not also within set of tracing packets 112 that is recorded as having arrived at packet processing 136.

In some examples, a traffic engineering tunnel 220 is created, passing through at least some nodes between packet source 120 and packet destination 130 (e.g., within packet switched network 200). A tunnel probe 222 (e.g., a probe packet) is used to monitor the performance of the tunnel, and acts as an automatic trigger to begin packet capture and analysis, rather than waiting for network user 102 to report performance problems.

FIG. 3 illustrates further detail for distributed packet capture and analysis service 300. Distributed packet capture and analysis service 300 has a front end 302, which may include API functionality, and a validation service 304. Front end 302 calls validation service 304 (e.g., using an API), which interfaces with a packet trace orchestrator 310 that has a metadata retrieval function 312, and a metadata processor 314, and either has its own storage 316 or uses available external storage in place of storage 316. Metadata retrieval function 312 retrieves topology data 320, which is topology information for packet switched network 200 and may be in the form of metadata. Metadata processor 314 uses topology data 320 to generate a network topology 322, which has the topology of packet switched network 200. In some examples, storage 316 provides for structured and unstructured storage data, possibly using different underlying storage solutions.

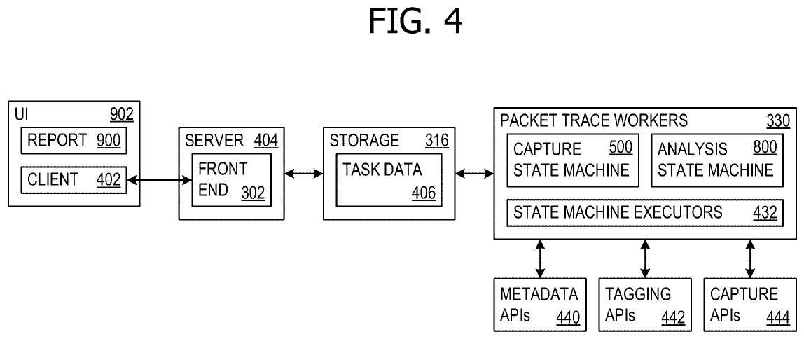

A set of packet trace workers 330 has a task processor 332 (see state machine executors 432 of FIG. 4) to process retrieval and capture tasks, a pcap file parser 334, and an analyzer 336 that analyzes the results of parsing pcap-extension files 153, for reporting to validation service 304. In some examples, metadata retrieval function 312 uploads tasking of packet trace workers 330 to storage 316 as structured data, from which packet trace workers 330 retrieve the tasking (as described below in relation to FIG. 4). Packet trace workers 330 from a network watcher 340 of capture service 142, and download pcap-extension files 153. In some examples, pcap file parser 334 saves pcap-extension files 153 in storage 316 as unstructured data, along with sending the parsing results to analyzer 336.

In some examples, pcap file parser 334 filters packets using network flow 5-tuple information (e.g., ports). Analyzer 336 sorts the packets by the capturing device (e.g., one of network nodes 201-208 and the others), and packet counting is performed for retransmissions. The results are re-sorted into groups by network layer to identify dropped tracing packets 114. A network trace is created to identify last-visited network node 210 for each dropped packet (e.g., dropped tracing packet 114a).

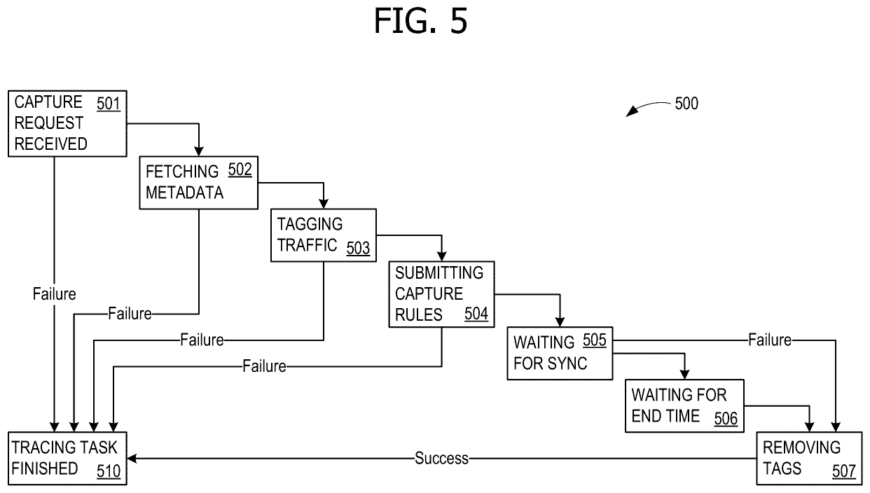

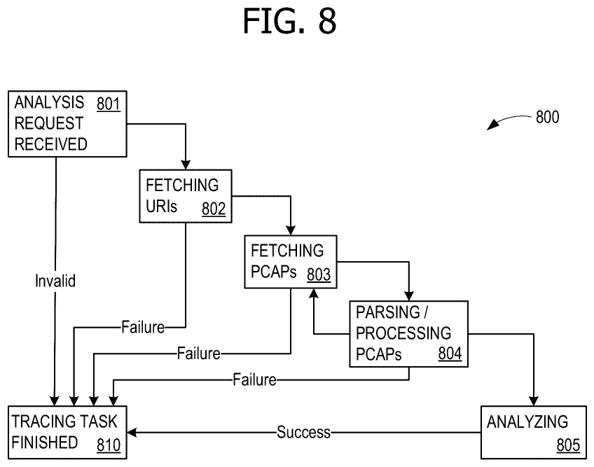

FIG. 4 illustrates an alternative representation for aspects of FIG. 3. Network technician 104 uses a client 402 in UI 902 (shown in FIG. 9), or some other way, to initiate the packet captures with front end 302, which is executing on a server 404. Task data 406 is stored in storage 316, as structured data, in some examples, and is retrieved by packet trace workers 330. Packet trace workers 330 each has two state machines, a capture state machine 500 (shown in FIG. 5) and an analysis state machine 800 (shown in FIG. 8). These, operating using state machine executors 432, provide the functionality described previously, in relation to FIGS. 1-3, for retrieving topology data 320, tagging packets, capturing packets, and analyzing the captures. Packet trace workers 330 interface with each of metadata APIs 440 for retrieving topology data 320, tagging APIs 442 for tagging packets, and capture APIs 444 for capturing packets

FIG. 5 illustrates capture state machine 500, which has seven intermediate states, each with their own input, input validator, executor (e.g., one of machine executors 432), and output classes. The states are: capture request received 501, fetching metadata 502, tagging traffic 503, submitting capture rules 504, waiting for packet capture rules to sync 505, waiting for packet capture end time 506, and removing tagging 507. Capture request received 501 starts when distributed packet capture and analysis service 300 instructs the nodes to begin packet captures and tagging. In some examples, captures last between 15 minutes and 7 days. The capture instructions are compared with capture criteria. If the capture instruction is valid, capture state machine 500 moves to the next state. If not (per the capture criteria), capture state machine 500 fails to the final state 510 of tracing task finished, but noting a failure.

Fetching metadata 502 starts when retrieving topology data 320), and the output may be a network topology object. Success moves capture state machine 500 to the next state, but failure moves capture state machine 500 to final state 510, noting a failure. Tagging traffic 503 is when tag 600 is being applied to set of tracing packets 111, and attempts to tag all forward direction traffic (i.e., toward packet destination 130). Success moves capture state machine 500 to the next state, but failure to tag all forward direction traffic moves capture state machine 500 to final state 510, noting a failure.

Submitting capture rules 504 is when various capture rules are disseminated to the nodes intended to capture packets. The rules may be in the form of strings with JSON formatting, and include topics such as whether a capture is a host capture, the node cluster and region, an IP address of the node, and others. Success moves capture state machine 500 to the next state, but failure moves capture state machine 500 to final state 510, noting a failure. Waiting for packet capture rules to sync 505 may have a maximum wait time. If some or all of the packet capture rules have synced by the maximum wait time, capture state machine 500 moves to the next state, otherwise capture state machine 500 skips the next state and moves to the one after (507). In some examples, determination of sync completion is on a 20-second repeat cycle.

Waiting for packet capture end time 506 remains until the end of the time specified in the capture instruction that started capture request received 501. Capture state machine 500 then moves to the next state. Removing tagging 507 is when tag 600 is removed from set of tracing packets 112.

FIG. 6 illustrates an exemplary packet tagging scheme for a tracing packet 111a of set of tracing packets 111. Tracing packet 111a has a packet header 601 and a payload comprising data 602. Header 601 has a version length field 611, a type of service (ToS) field 612, a length value 613, an identifier (ID) 614, an offset value 615, a time to live (TTL) value 616, a protocol identifier 617, a frame check sequence (FCS) 618, a source address 619 (e.g., of packet source 120), and a destination address 620 (e.g., of packet destination 130).

ToS field 612 contains a differentiated services codepoint (DSCP) 630 for classifying and managing network traffic and of indicating quality of service (QoS). In some examples, ToS field 612 is a byte of eight (8) bits. The bits, from most significant to least significant, are seven bit B7, six bit B6, five bit B5, four bit B4, three bit B3, two bit B2, one bit B1, zero bit B0. The first three (3) bits of DSCP 630, B5-B7, are IP precedence bits 631, and the final two, B0 and B1, are unused bits 632 in many applications. In such applications, one bit B1 and zero bit B0 are both set to zero (0).

In some examples, tag 600 is the setting of both five bit B5 (the fifth bit) and zero bit B0 to a value of 1. The use to tag 600 simplifies packet capture. Rather than setting complicated packet capture rules that only attempt to capture set of tracing packets 111, a wider set of packets are captured as captured packets 113. Tag 600 offloads the filtering to the capture points, rather than burdening a limited set of packet trace workers 330. This solution improves the accuracy with which relevant packets are captured, significantly reduces the time to capture, and reduces the processing power needed to process the captured packets to produce a report of the results.

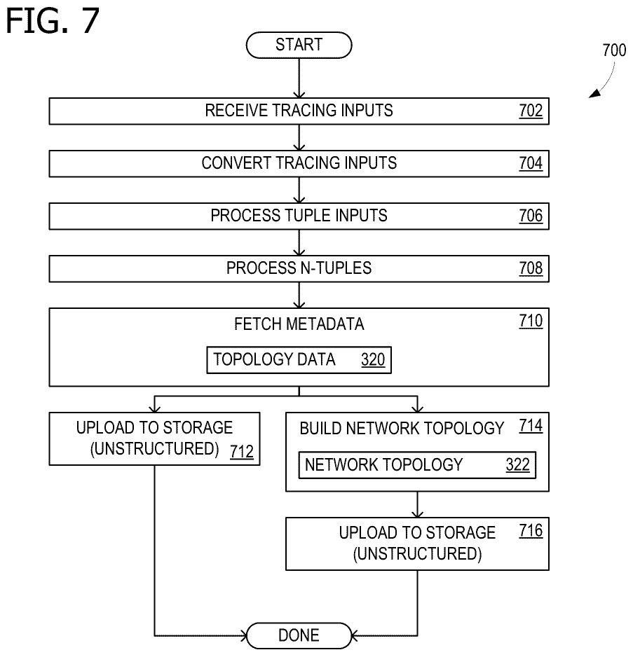

FIG. 7 shows a flowchart 700 illustrating exemplary operations for constructing network topology 322 for packet switched network 200. Tracing inputs, such as a container ID for a VM and an IP address (including a possible VIP address) are received in operation 702. The tracing inputs are converted in operation 704, and operation 706 process network flow tuple inputs, such as cluster, node ID, container ID, and other 5-tuple information. Operation 708 process the network flow N-tuples (e.g., 5-tuples).

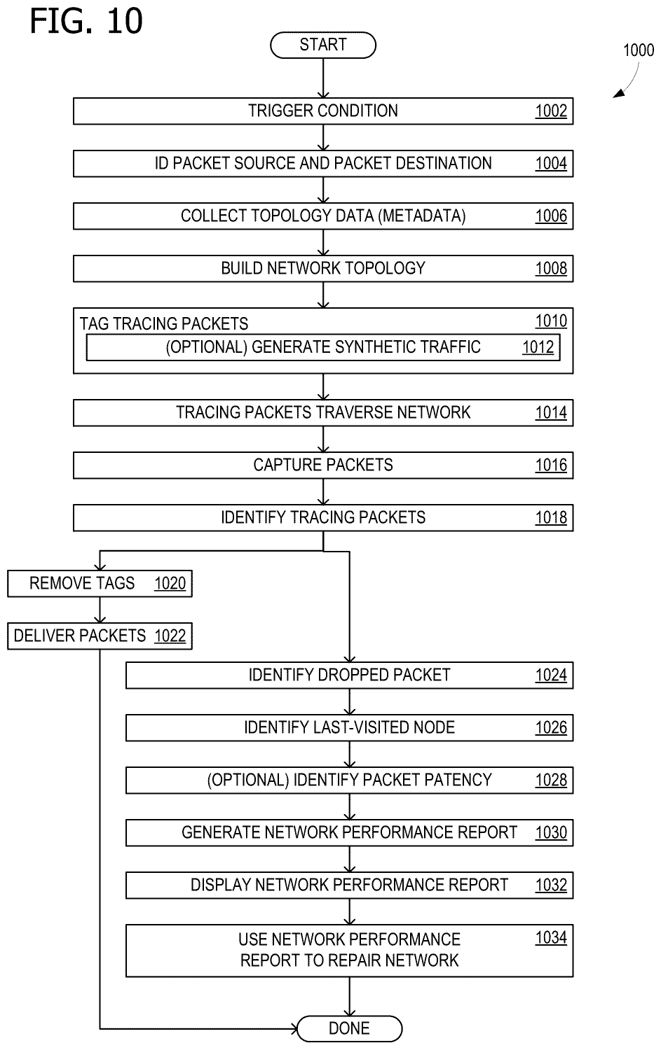

Operation 710 fetches topology data 320 (see also operation 1006 of FIG. 10), and operation 712 saves topology data 320 to storage 316. In parallel, operation 714 generates network topology 322 using topology data 320 (see also operation 1008 of FIG. 10), and operation 716 uploads network topology 322 to storage 316.

FIG. 8 illustrates analysis state machine 800, which performs packet analysis, such as described for analyzer 336. Analysis state machine 800 has five intermediate states, each with their own input, input validator, executor (e.g., one of machine executors 432), and output classes. The states are: analysis request received 801, fetching packet capture URIs 802, download capture files 803, processing capture files 804, and analyze capture files 805.

Analysis request received 801 starts when an analysis request is received. If the request is valid, analysis state machine 800. Otherwise, analysis state machine 800 fails to the final state 810 of tracing task finished, but noting a failure. For each of the remaining states, success moves analysis state machine 800 to the next state, while a failure moves analysis state machine 800 to final state 810, noting a failure. The capture files used in download capture files 803, processing capture files 804, and analyze capture files 805 are pcap-extension files 153. Upon successful completion of analyze capture files 805, analysis state machine 800 moves to final state 810, noting successful completion.

FIG. 9 illustrates an example of UI 902 an example network performance report 900, which is illustrated as a dropped packet report. Network performance report 900 has an indication 910 of dropped tracing packet 114a, as part of the 528 dropped tracing packets 114, and may have an indication of a corrupted tracing packet, in some examples. An indication 912 identifies “dst_leafrouter”, which is network node 208, as last-visited network node 210. The illustrated network performance report 900 also has an indication 914 of packet latency, although in some examples, indication 914 may be specific to a network node.

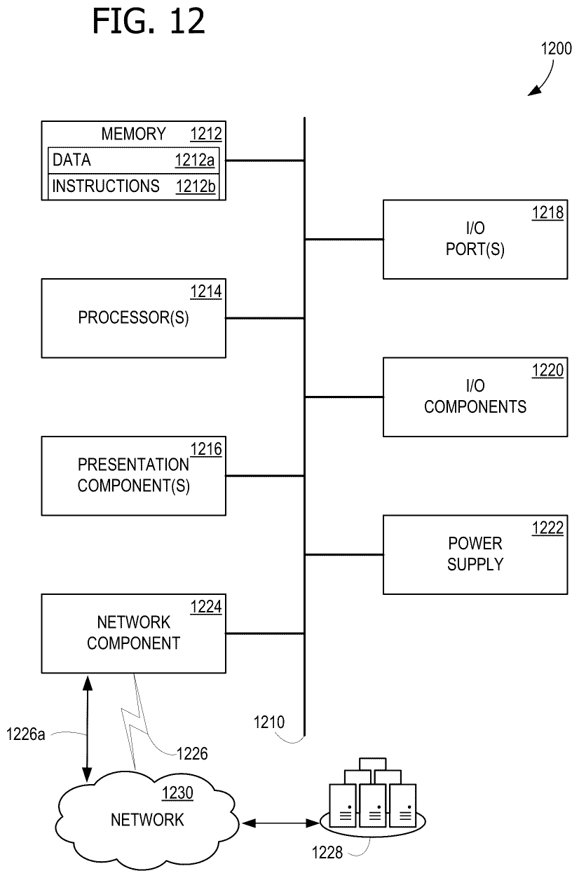

FIG. 10 shows a flowchart 1000 illustrating exemplary operations that may be performed by architecture 100. In some examples, operations described for flowchart 1000 are performed by computing device 1200 of FIG. 12. Flowchart 1000 commences with identify a trigger condition for collecting topology data 320, in operation 1002. In some examples, the trigger condition may be receiving an indication of a network error (e.g., poor performance) from network user 102 or receiving an indication of a network error from using tunnel probe 222 (e.g., tunnel probe 222 is lost).

Operation 1004 identifies packet source 120 and packet destination 130 that are each communicatively coupled to packet switched network 200, possibly using input from network user 102. In some examples, packet source 120 and packet destination 130 are host devices. Operation 1006 collects topology data 320 for packet switched network 200, and operation 1008 builds network topology 322 of the network nodes of packet switched network 200 using the collected topology data 320. Network topology 322 comprises at least network nodes communicatively disposed between packet source 120 and packet destination 130.

Operation 1010 tags set of tracing packets 111 with tag 600. In some examples, each of the tracing packets has a common network flow 5-tuple. In some examples, tag 600 comprises a bit pattern flag in the DSCP field (e.g. DSCP 630) in each packet of set of tracing packets 111. In some examples, the bit pattern flag comprises setting each of the zero bit and the fifth bit of the DSCP field to one, such that an AND operation (&&) of a hex value of 0x21 and the DSCP field produces a hex value of 0x21. Set of tracing packets 111 may be customer data traffic packets or synthetic data traffic packets. When synthetic data traffic is used, operation 1012 generates synthetic data traffic packets to use as (at least some of) set of tracing packets 111.

In operation 1014, set of tracing packets 111 traverses packet switched network 200 from packet source 120 to packet destination 130 (except dropped tracing packet 114a, which is lost along the way). Operation 1016 captures captured packets 113 from packet switched network 200, including packets from the host devices (e.g., packet source 120 and packet destination 130). Operation 1018 identifies set of tracing packets 112 within captured packets 113 using tag 600. In general operations 1010-1018 use packet encapsulation to identify incoming and outgoing traffic for network nodes.

Operations 1020 and 1022 are performed in parallel with the remainder of flowchart 1000. Operation 1020 removes tag 600 from each packet of set of tracing packets 112, and operation 1022 delivers set of tracing packets 112 to their final destination (e.g., VMs 138a-138c).

Dropped tracing packet 114a, and others of dropped tracing packets 114, are identified using set of tracing packets 112 and set of tracing packets 111, in operation 1024. Last-visited network node 210 of dropped tracing packet 114a is identified using network topology 322 in operation 1026, and operation 1028 identifies packet latency and/or identifies any source(s) of packet corruption, using network topology 322. Operation 1030 generates network performance report 900, which indicates dropped tracing packet 114a (e.g., among dropped tracing packets 114) and last-visited network node 210.

Operation 1032 displays network performance report 900 in UI 902. In some examples, network performance report 900 comprises a dropped packet report, and in some examples further indicates network latency for a network node. In operation 1034, network technician 104 uses network performance report 900 to facilitate rapid repair of packet switched network 200 to restore performance for network user 102.

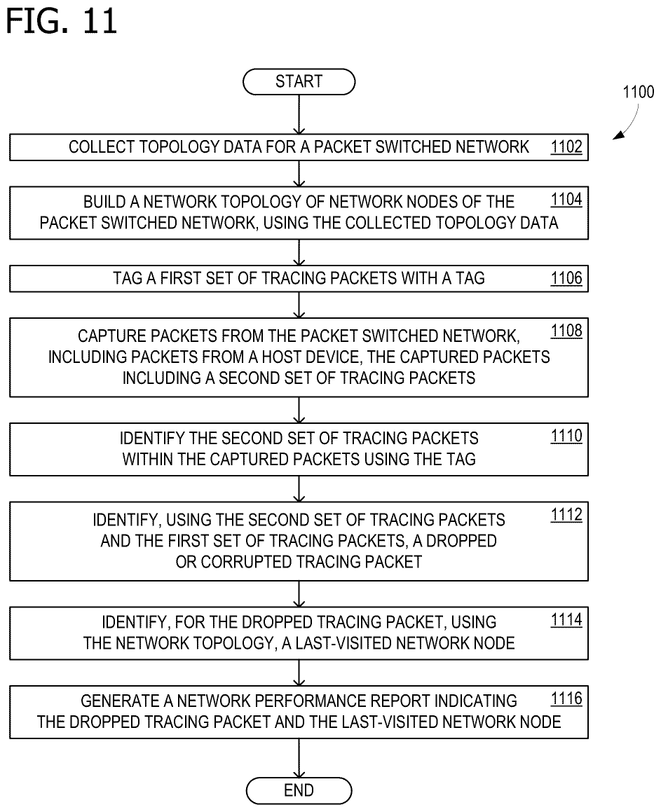

FIG. 11 shows a flowchart 1100 illustrating exemplary operations that may be performed by architecture 100. In some examples, operations described for flowchart 1100 are performed by computing device 1200 of FIG. 12. Flowchart 1100 commences with operation 1102, which includes collecting topology data for a packet switched network. Operation 1104 includes building a network topology of network nodes of the packet switched network, using the collected topology data. Operation 1106 includes tagging a first set of tracing packets with a tag.

Operation 1108 includes capturing packets from the packet switched network, including packets from a host device, the captured packets including a second set of tracing packets. Operation 1110 includes identifying the second set of tracing packets within the captured packets using the tag. Operation 1112 includes identifying, using the second set of tracing packets and the first set of tracing packets, a dropped or corrupted tracing packet. Operation 1114 includes identifying, for the dropped tracing packet, using the network topology, a last-visited network node. Operation 1116 includes generating a network performance report indicating the dropped tracing packet and the last-visited network node.

### Additional Examples

An example system comprises: a processor; and a computer-readable medium storing instructions that are operative upon execution by the processor to: collect topology data for a packet switched network; build a network topology of network nodes of the packet switched network, using the collected topology data; tag a first set of tracing packets with a tag; capture packets from the packet switched network, including packets from a host device, the captured packets including a second set of tracing packets; identify the second set of tracing packets within the captured packets using the tag; identify, using the second set of tracing packets and the first set of tracing packets, a dropped or corrupted tracing packet; identify, for the dropped packet, using the network topology, a last-visited network node; and generate a network performance report indicating the dropped tracing packet and the last-visited network node.

An example computer-implemented method comprises: creating, in a packet switched network, a first primary tunnel comprising: creating, in a packet switched network, a first primary tunnel comprising: collecting topology data for a packet switched network; building a network topology of network nodes of the packet switched network, using the collected topology data; tagging a first set of tracing packets with a tag; capturing packets from the packet switched network, including packets from a host device, the captured packets including a second set of tracing packets; identifying the second set of tracing packets within the captured packets using the tag; identifying, using the second set of tracing packets and the first set of tracing packets, a dropped or corrupted tracing packet; identifying, for the dropped tracing packet, using the network topology, a last-visited network node; and generating a network performance report indicating the dropped tracing packet and the last-visited network node.

One or more example computer storage devices have computer-executable instructions stored thereon, which, on execution by a computer, cause the computer to perform operations comprising: creating, in a packet switched network, a first primary tunnel comprising: collecting topology data for a packet switched network; building a network topology of network nodes of the packet switched network, using the collected topology data; tagging a first set of tracing packets with a tag; capturing packets from the packet switched network, including packets from a host device, the captured packets including a second set of tracing packets; identifying the second set of tracing packets within the captured packets using the tag; identifying, using the second set of tracing packets and the first set of tracing packets, a dropped or corrupted tracing packet; identifying, for the dropped tracing packet, using the network topology, a last-visited network node; and generating a network performance report indicating the dropped tracing packet and the last-visited network node.

Alternatively, or in addition to the other examples described herein, examples include any combination of the following:
identifying a trigger condition for collecting the topology data;
the trigger condition comprises receiving an indication of a network error from a network user;
the trigger condition comprises receiving an indication of a network error from a tunnel probe;
identifying packet latency using the network topology;
the network performance report further indicates network latency for a network node;
identifying a packet source communicatively coupled to the packet switched network;
identifying a packet destination communicatively coupled to the packet switched network;
the host device comprises the packet source;
the host device comprises the packet destination;
the network topology comprises the network nodes communicatively disposed between the packet source and the packet destination;
displaying the network performance report in a UI;
removing the tag from packets of the second set of tracing packets;
each of the tracing packets has a common network flow 5-tuple;
the topology data comprises metadata;
the tag comprises a bit pattern flag in a DSCP field of a packet;
the bit pattern flag comprises setting each of a zero bit and a fifth bit of the DSCP field to one, such that an AND operation of a hex value of 0x21 and the DSCP field produces a hex value of 0x21;
the first set of tracing packets comprises customer data traffic packets;
the first set of tracing packets comprises synthetic data traffic packets;
the network performance report comprises a dropped packet report; and
using packet encapsulation to identify incoming and outgoing traffic for a network node.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 12 is a block diagram of an example computing device 1200 (e.g., a computer storage device) for implementing aspects disclosed herein, and is designated generally as computing device 1200. In some examples, one or more computing devices 1200 are provided for an on-premises computing solution. In some examples, one or more computing devices 1200 are provided as a cloud computing solution. In some examples, a combination of on-premises and cloud computing solutions are used. Computing device 1200 is but one example of a suitable computing environment and is not intended to suggest any limitation as to the scope of use or functionality of the examples disclosed herein, whether used singly or as part of a larger set.

Neither should computing device 1200 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1200 includes a bus 1210 that directly or indirectly couples the following devices: computer storage memory 1212, one or more processors 1214, one or more presentation components 1216, input/output (I/O) ports 1218, I/O components 1220, a power supply 1222, and a network component 1224. While computing device 1200 is depicted as a seemingly single device, multiple computing devices 1200 may work together and share the depicted device resources. For example, memory 1212 may be distributed across multiple devices, and processor(s) 1214 may be housed with different devices.

Bus 1210 represents what may be one or more busses (such as an address bus, data bus, or a combination thereof). Although the various blocks of FIG. 12 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 12 and the references herein to a “computing device.” Memory 1212 may take the form of the non-transitory computer storage media referenced below and operatively provide storage of computer-readable instructions, data structures, program modules and other data for the computing device 1200. In some examples, memory 1212 stores one or more of an operating system, a universal application platform, or other program modules and program data. Memory 1212 is thus able to store and access data 1212a and instructions 1212b that are executable by processor 1214 and configured to carry out the various operations disclosed herein.

In some examples, memory 1212 includes computer storage media. Memory 1212 may include any quantity of memory associated with or accessible by the computing device 1200. Memory 1212 may be internal to the computing device 1200 (as shown in FIG. 12), external to the computing device 1200 (not shown), or both (not shown). Additionally, or alternatively, the memory 1212 may be distributed across multiple computing devices 1200, for example, in a virtualized environment in which instruction processing is carried out on multiple computing devices 1200. For the purposes of this disclosure, “computer storage media,” “computer storage memory,” “memory,” and “memory devices” are synonymous terms for the memory 1212, and none of these terms include carrier waves or propagating signaling.

Processor(s) 1214 may include any quantity of processing units that read data from various entities, such as memory 1212 or I/O components 1220. Specifically, processor(s) 1214 are programmed to execute computer-executable instructions for implementing aspects of the disclosure. The instructions may be performed by the processor, by multiple processors within the computing device 1200, or by a processor external to the client computing device 1200. In some examples, the processor(s) 1214 are programmed to execute instructions such as those illustrated in the flow charts discussed below and depicted in the accompanying drawings. Moreover, in some examples, the processor(s) 1214 represent an implementation of analog techniques to perform the operations described herein. For example, the operations may be performed by an analog client computing device 1200 and/or a digital client computing device 1200. Presentation component(s) 1216 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1200, across a wired connection, or in other ways. I/O ports 1218 allow computing device 1200 to be logically coupled to other devices including I/O components 1220, some of which may be built in. Example I/O components 1220 include, for example but without limitation, a microphone, joystick, game pad, satellite dish, scanner, printer, wireless device, etc.

Computing device 1200 may operate in a networked environment via the network component 1224 using logical connections to one or more remote computers. In some examples, the network component 1224 includes a network interface card and/or computer-executable instructions (e.g., a driver) for operating the network interface card. Communication between the computing device 1200 and other devices may occur using any protocol or mechanism over any wired or wireless connection. In some examples, network component 1224 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1224 communicates over wireless communication link 1226 and/or a wired communication link 1226a to a remote resource 1228 (e.g., a cloud resource) across network 1230. Various different examples of communication links 1226 and 1226a include a wireless connection, a wired connection, and/or a dedicated link, and in some examples, at least a portion is routed through the internet.

Although described in connection with an example computing device 1200, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
collect topology data for a packet switched network;
build a network topology of network nodes of the packet switched network, using the collected topology data;
tag a first set of tracing packets with a tag;
capture packets from the packet switched network, including packets from a host device, the captured packets including a second set of tracing packets;
identify the second set of tracing packets within the captured packets using the tag;
identify, using the second set of tracing packets and the first set of tracing packets, a dropped or corrupted tracing packet;
identify, for the dropped tracing packet, using the network topology, a last-visited network node; and
generate a network performance report indicating the dropped tracing packet and the last-visited network node.

2. The system of claim 1, wherein the instructions are further operative to:
identifying a trigger condition for collecting the topology data, the trigger condition comprising receiving an indication of a network error from a network user or receiving an indication of a network error from a tunnel probe.

3. The system of claim 1, wherein the instructions are further operative to:
identify packet latency using the network topology, wherein the network performance report further indicates network latency for a network node.

4. The system of claim 1, wherein the instructions are further operative to:
identify a packet source communicatively coupled to the packet switched network; and
identify a packet destination communicatively coupled to the packet switched network, wherein the host device comprises the packet source or the packet destination, and wherein the network topology comprises the network nodes communicatively disposed between the packet source and the packet destination.

5. The system of claim 1, wherein the instructions are further operative to:
display the network performance report in a user interface (UI).

6. The system of claim 1, wherein the instructions are further operative to:
remove the tag from packets of the second set of tracing packets.

7. The system of claim 1, wherein each packet of the first set of tracing packets has a common network flow 5-tuple.

8. A computer-implemented method comprising:
collecting topology data for a distributed packet switched network;
building a network topology of network nodes of the packet switched network, using the collected topology data;
tagging a first set of tracing packets with a tag;
capturing packets from the packet switched network, including packets from a host device, the captured packets including a second set of tracing packets;
identifying the second set of tracing packets within the captured packets using the tag;
identifying, using the second set of tracing packets and the first set of tracing packets, a dropped or corrupted tracing packet;
identifying, for the dropped tracing packet, using the network topology, a last-visited network node; and
generating a network performance report indicating the dropped tracing packet and the last-visited network node.

9. The computer-implemented method of claim 8, further comprising:
identifying a trigger condition for collecting the topology data, the trigger condition comprising receiving an indication of a network error from a network user or receiving an indication of a network error from a tunnel probe.

10. The computer-implemented method of claim 8, further comprising:
identifying packet latency using the network topology, wherein the network performance report further indicates network latency for a network node.

11. The computer-implemented method of claim 8, further comprising:
identifying a packet source communicatively coupled to the packet switched network; and
identifying a packet destination communicatively coupled to the packet switched network, wherein the host device comprises the packet source or the packet destination, and wherein the network topology comprises the network nodes communicatively disposed between the packet source and the packet destination.

12. The computer-implemented method of claim 8, further comprising:
displaying the network performance report in a user interface (UI).

13. The computer-implemented method of claim 8, further comprising:
removing the tag from packets of the second set of tracing packets.

14. The computer-implemented method of claim 8, wherein each packet of the first set of tracing packets has a common network flow 5-tuple.

15. A computer storage device having computer-executable instructions stored thereon, which, on execution by a computer, cause the computer to perform operations comprising:
collecting topology data for a packet switched network;
building a network topology of network nodes of the packet switched network, using the collected topology data;
tagging a first set of tracing packets with a tag;
capturing packets from the packet switched network, including packets from a host device, the captured packets including a second set of tracing packets;
identifying the second set of tracing packets within the captured packets using the tag;
identifying, using the second set of tracing packets and the first set of tracing packets, a dropped or corrupted tracing packet;
identifying, for the dropped tracing packet, using the network topology, a last-visited network node; and
generating a network performance report indicating the dropped tracing packet and the last-visited network node, and/or indicating packet latency.

16. The computer storage device of claim 15, wherein the operations further comprise:
identifying a trigger condition for collecting the topology data, the trigger condition comprising receiving an indication of a network error from a network user or receiving an indication of a network error from a tunnel probe.

17. The computer storage device of claim 15, wherein the operations further comprise:
identifying a packet source communicatively coupled to the packet switched network; and
identifying a packet destination communicatively coupled to the packet switched network, wherein the host device comprises the packet source or the packet destination, and wherein the network topology comprises the network nodes communicatively disposed between the packet source and the packet destination.

18. The computer storage device of claim 15, wherein the operations further comprise:
displaying the network performance report in a user interface (UI).

19. The computer storage device of claim 15, wherein the operations further comprise:
removing the tag from packets of the second set of tracing packets.

20. The computer storage device of claim 15, wherein each packet of the first set of tracing packets has a common network flow 5-tuple.
